(19) United States
(12) Patent Application Publication
(10) Pub. No.: US 2024/0052158 A1
(43) Pub. Date: Feb. 15, 2024

(54) POLYCARBONATE POLYESTER COMPOSITION, MOLDING COMPOUND AND MOLDING BODY HAVING A GOOD IMPACT STRENGTH AND HIGH THERMAL LOADING CAPABILITY

(71) Applicant: Covestro Deutschland AG, Leverkusen (DE)

(72) Inventors: Ralf Hufen, Duisburg (DE); Sven Hobeika, Solingen (DE); Marius Nolte, Köln (DE)

(21) Appl. No.: 18/262,754

(22) PCT Filed: Feb. 1, 2022
(86) PCT No.: PCT/EP2022/052279

§ 371 Date: Jul. 25, 2023

(30) Foreign Application Priority Data
Feb. 8, 2021 (EP) 21155830.9

(51) Int. Cl. C08L 69/00

(52) U.S. Cl. CPC C08L 69/00

(57) ABSTRACT

The present invention relates to a composition for producing a thermoplastic molding compound, the composition comprising the following constituents or consisting therefrom: A) at least one polymer selected from the group consisting of polycarbonate and polyester carbonate, B) at least one polyester, C) phosphorous acid, D) at least one phosphonite, and E) at least one sterically hindered phenol. Furthermore, the present invention relates to a method for producing a thermoplastic molding compound from the composition, to the molding compound itself, and to the use of the composition and the molding compound for producing molding bodies.

The present invention relates to a composition based on polycarbonate and polyester for producing a thermoplastic molding compound, to the molding compound itself, to the use of the composition or molding compound for producing molded bodies and to the molded bodies themselves.

Thermoplastic molding compounds comprising polycarbonate and/or polyester carbonate and polyester have been known for a long time.

They are used for components in a wide range of industrial sectors, especially in the automotive industry. By varying the constituents in terms of type and amount and adding further additives and polymeric blend partners, the property profiles can be adapted over a wide range to the requirements of the respective applications.

For many such applications, the components produced from the molding compounds must withstand relatively high temperatures and also have good mechanical properties, such as high resilience under impact stress.

During production of the polycarbonate-polyester molding compounds during melt compounding and/or during processing of the molding compounds, for example during injection molding, undesired transesterification reactions between the polycarbonate and the polyester often occur. Such reactions occur particularly under unfavorable conditions such as high temperatures, long residence times and under high mechanical stresses during melt compounding or during injection molding.

This can result in impairment of important properties. For instance, heat distortion resistance or resilience of the molded bodies may be reduced. In addition, morphological properties may be altered, i.e. the crystallization and melt behavior of the polyester may be disrupted and the glass transition temperature of the polycarbonate shifted to lower values. However, rapid crystallization has a positive effect on the demolding behavior during injection molding processing and thus reduces cycle times, making component production more efficient. Undisrupted crystallization is also advantageous for resistance to aggressive media.

It is therefore desirable to provide the molding compounds composed of polycarbonate and polyester with an additive for stabilization. There are numerous documents relating to this in the prior art.

WO 85/02622 discloses polycarbonate-polyester compositions stabilized against yellowing with phosphorus-based acids.

DE 2414849 A1 discloses mixtures of polycarbonate and polyester protected against discoloration with phosphorus compounds.

EP 0417421 A1 discloses sterically hindered esters of phosphorous acid as stabilizers for polycarbonate-polyalkylene terephthalate compositions.

EP 3608358 A1 discloses compositions comprising polycarbonate, polyalkylene terephthalate, a mineral filler and phosphorous acid as stabilizer.

U.S. Pat. No. 4,088,709 A discloses a composition which consists of a mixture of polytetramethylene terephthalate, bisphenol A polycarbonate and selected phosphorus compounds and which is characterized by good mechanical properties.

DE 2402367 discloses a polycarbonate composition stabilized against thermal degradation by using a small amount of a phosphite, which may be either a diaryl hydrogen phosphite, a dialkyl hydrogen phosphite or an alkylaryl hydrogen phosphite or mixtures thereof, as stabilizer.

EP 0604074 A1 discloses blend compositions of two polyesters, which may also comprise polycarbonate and in which the melt viscosity can be stabilized with certain phosphorus-containing additives.

EP 0114288 A2 discloses that thermoplastic compositions composed of a polyester resin and/or polycarbonate resin, an acrylic core-shell impact modifier and a stabilizer package are provided by an improved process in which the impact modifier and stabilizer components are first premixed and the premix is then mixed with the polyester and/or polycarbonate. The resulting blend composition retains good properties even without the use of high amounts of the stabilizers.

EP 0604080 discloses a composition comprising polybutylene terephthalate or polyethylene terephthalate or mixtures of polybutylene terephthalate and polyethylene terephthalate, polycarbonate, inorganic filler, a stabilizer and optionally a styrene rubber impact modifier.

Even though the stabilization of polycarbonate/polyester compositions is described in many documents, there was still a need for improvements.

It was desirable to provide a composition for producing a thermoplastic molding compound where the molding compound is suitable for producing molded bodies having improved impact strength. Furthermore, it was desirable that the heat distortion resistance of the molded bodies is decreased only slightly, even if the molded bodies are produced under unfavorable processing conditions, such as very high temperatures and/or very long residence times. The aim is therefore to ensure that the heat distortion resistance is only influenced by the processing conditions to the smallest possible extent, thereby improving the reproducibility of this property.

It was also desirable for the aforementioned transition temperatures, i.e. the crystallization temperature of the polyester, the melting point of the polyester and the glass transition temperature of the polycarbonate, to be at the highest possible values, so that good phase separation is achieved.

It has now been found that, surprisingly, the desired properties are exhibited by a composition for producing a thermoplastic molding compound, wherein the composition comprises or consists of the following constituents:
A) at least one polymer selected from the group consisting of polycarbonate and polyester carbonate,
B) at least one polyester,
C) phosphorous acid,
D) at least one phosphonite,
E) at least one sterically hindered phenol.

As component F, the composition optionally comprises at least one mineral filler based on talc and also optionally as component G, at least one additive selected from the group consisting of lubricants and mold-release agents, flame retardants, flame retardant synergists, conductivity additives, UV/light protectants, nucleating agents, hydrolysis protectants, scratch resistance improving additives, IR absorbents, optical brighteners, fluorescent additives, impact modifiers, dyes and pigments, and also fillers and reinforcers other than component F.

In a preferred embodiment, the composition comprises
40 to 80% by weight, more preferably from 45 to 75% by weight, particularly preferably from 50 to 66% by weight, of component A,
15 to 45% by weight, more preferably 18 to 40%, particularly preferably 20% to 35% by weight, of component B,
0.005 to 0.1% by weight, more preferably 0.008 to 0.06% by weight, particularly preferably 0.01 to 0.05% by weight, of component C,
0.05 to 1% by weight, more preferably 0.08 to 0.8% by weight, particularly preferably 0.1 to 0.3% by weight, of component D,
0.05 to 1% by weight, more preferably 0.08 to 0.8% by weight, particularly preferably 0.1 to 0.3% by weight, of component E,
0 to 25% by weight, more preferably 0 to 20% by weight, particularly preferably 5 to 20% by weight, of component F and
0 to 20% by weight, more preferably 0.1 to 15% by weight, particularly preferably 0.2 to 10% by weight, of component G.

All percentages by weight refer to the total composition unless otherwise stated.

In a preferred embodiment the composition consists of the components A to G to an extent of 90% by weight, more preferably to an extent of 95% by weight and particularly preferably to an extent of 100% by weight.

The individual aforementioned preferential ranges of different components and the preferred embodiments may be freely combined with one another.

Component A

Aromatic polycarbonates and/or aromatic polyestercarbonates of component A which are suitable in accordance with the invention are known from the literature or producible by processes known from the literature (for production of aromatic polycarbonates see, for example, Schnell, “Chemistry and Physics of Polycarbonates”, Interscience Publishers, 1964, and also DE-AS 1 495 626, DE-A 2 232 877, DE-A 2 703 376, DE-A 2 714 544, DE-A 3 000 610, DE-A 3 832 396; for production of aromatic polyestercarbonates, for example DE-A 3 007 934).

Aromatic polycarbonates are produced for example by reaction of diphenols with carbonyl halides, preferably phosgene and/or with aromatic dicarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of diphenols with for example diphenyl carbonate is likewise possible.

Diphenols for production of the aromatic polycarbonates and/or aromatic polyester carbonates are preferably those of formula (1)

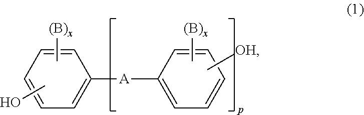

where
A is a single bond, C₁ to C₅-alkylene, C₂ to C₅-alkylidene, C₅ to C₆-cycloalkylidene, —O—, —SO, —CO—, —S—, —SO₂—, C₆ to C₁₂-arylene, onto which further aromatic rings optionally containing heteroatoms may be fused,
   or a radical of formula (2) or (3)

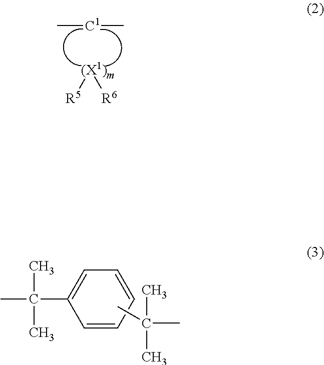

B is in each case C₁ to C₁₂-alkyl, preferably methyl, halogen, preferably chlorine and/or bromine,
x is each independently 0, 1 or 2,
p is 1 or 0, and
R⁵ and R⁶ can be selected individually for each X¹ and are each independently hydrogen or C₁ to C₆-alkyl, preferably hydrogen, methyl or ethyl,
X1 is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone, and also the di- and tetrabrominated or chlorinated derivatives thereof, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is especially preferred.

The diphenols may be used individually or in the form of any desired mixtures. The diphenols are known from the literature or obtainable by literature processes.

Examples of chain terminators suitable for the production of the thermoplastic aromatic polycarbonates include phenol, p-chlorophenol, p-tert-butylphenol or 2,4,6-tribromophenol, and also long-chain alkylphenols such as 4-[2-(2,4,4-trimethylpentyl)]phenol, 4-(1,3-tetramethylbutyl)phenol according to DE-A 2 842 005 and monoalkylphenol or dialkylphenols having a total of from 8 to 20 carbon atoms in the alkyl substituents, for example 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The thermoplastic aromatic polycarbonates have average molecular weights (weight-average MW, measured by GPC (gel permeation chromatography) using a polycarbonate standard based on bisphenol A) of 20 to 40 kg/mol, preferably 20 to 32 kg/mol, particularly preferably 22 to 28 kg/mol. The preferred ranges result in a particularly advantageous balance of mechanical and rheological properties in the compositions of the invention.

The thermoplastic aromatic polycarbonates may be branched in a known manner, and preferably through incorporation of 0.05 to 2.0 mol %, based on the sum total of the diphenols used, of trifunctional or more than trifunctional compounds, for example those having three or more phenolic groups. Preference is given to using linear polycarbonates, more preferably based on bisphenol A.

Both homopolycarbonates and copolycarbonates are suitable. Copolycarbonates of the invention as per component A may also be produced using 1 to 25% by weight, preferably 2.5 to 25% by weight, based on the total amount of diphenols to be used, of polydiorganosiloxanes having hydroxyaryloxy end groups. These are known (U.S. Pat. No. 3,419,634) and may be produced by processes known from the literature. Likewise suitable are polydiorganosiloxane-containing copolycarbonates; production of the polydiorganosiloxane-containing copolycarbonates is described in, for example, DE-A 3 334 782.

Aromatic dicarbonyl dihalides for production of aromatic polyestercarbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio between 1:20 and 20:1.

Production of polyestercarbonates additionally makes concomitant use of a carbonyl halide, preferably phosgene, as the bifunctional acid derivative.

In addition to the monophenols already mentioned, chain terminators for producing aromatic polyester carbonates include chlorocarbonic esters of these and the acyl chlorides of aromatic monocarboxylic acids, which may optionally be substituted by C₁ to C₂₂-alkyl groups or by halogen atoms, and also aliphatic C₂ to C₂₂-monocarboxylic acid chlorides.

The amount of chain terminators is in each case 0.1 to 10 mol %, based on moles of diphenol in the case of phenolic chain terminators and on moles of dicarboxylic acid dichloride in the case of monocarboxylic acid chloride chain terminators.

One or more aromatic hydroxycarboxylic acids may also be used in the production of aromatic polyestercarbonates.

The aromatic polyestercarbonates may be linear or branched in a known manner (see DE-A 2 940 024 and DE-A 3 007 934), wherein linear polyestercarbonates are preferred.

Branching agents that may be used are for example tri- or polyfunctional carbonyl chlorides, such as trimesoyl trichloride, cyanuroyl trichloride, 3,3′,4,4′-benzophenonetetracarbonyl tetrachloride, 1,4,5,8-naphthalenetetracarbonyl tetrachloride or pyromellitoyl tetrachloride, in amounts of 0.01 to 1.0 mol % (based on dicarbonyl dichlorides employed) or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in amounts of 0.01 to 1.0 mol % based on diphenols employed. Phenolic branching agents may be initially charged together with the diphenols; acid chloride branching agents may be introduced together with the acid dichlorides.

The proportion of carbonate structural units in the thermoplastic aromatic polyestercarbonates may be varied as desired. Preferably, the proportion of carbonate groups is up to 100 mol %, especially up to 80 mol %, more preferably up to 50 mol %, based on the sum total of ester groups and carbonate groups. The ester fraction of the aromatic polyester carbonates, and also the carbonate fraction thereof, can take the form of blocks or can have random distribution in the polycondensate.

The thermoplastic aromatic polycarbonates and polyestercarbonates may be used alone or in any desired mixture.

It is preferable to employ polycarbonate based on bisphenol A as component A.

The proportion of component A in the composition is preferably 40 to 80% by weight, more preferably 45 to 75% by weight, particularly preferably 50 to 66% by weight.

Component B

According to the invention, a polyester or a mixture of polyesters is used as component B.

The polyesters can be reaction products of aromatic, aliphatic, or cycloaliphatic dicarboxylic acids with aliphatic, cycloaliphatic, or araliphatic diols.

Diols used in the production of the polyesters according to the invention include for example ethylene glycol, butane-1,4-diol, propane-1,3-diol, tetramethylcyclobutanediol, isosorbitol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane and mixtures thereof (DE-A 2 407 674, 2 407 776, 2 715 932).

Cyclohexanedicarboxylic acid, for example, can be used as the cycloaliphatic carboxylic acid. A suitable polyester derived from this acid comprises cyclohexanedimethanol as the diol component and is referred to as PCCD. A process for producing such a polyester is described, for example, in U.S. Pat. No. 6,455,564 B 1.

The polyester of component D is preferably a polyalkylene terephthalate.

In a preferred embodiment they are reaction products of terephthalic acid or reactive derivatives thereof, such as dimethyl esters or anhydrides, and aliphatic, cycloaliphatic or araliphatic diols and also mixtures of these reaction products.

The polyalkylene terephthalates thus contain structural units derived from terephthalic acid and aliphatic, cycloaliphatic or araliphatic diols.

In the context of the present invention polyalkylene terephthalates is to be understood as also including polyesters which contain not only terephthalic acid radicals but also proportions of further aromatic, aliphatic or cycloaliphatic dicarboxylic acids in an amount of up to 50 mol %, preferably up to 25 mol %. These may contain, for example, aromatic or cycloaliphatic dicarboxylic acids having 8 to 14 carbon atoms or aliphatic dicarboxylic acids having 4 to 12 carbon atoms, for example phthalic acid, isophthalic acid, naphthalene-2,6-dicarboxylic acid, 4,4′-biphenyldicarboxylic acid, succinic acid, adipic acid and cyclohexanedicarboxylic acid.

Preference is given to using solely terephthalic acid and isophthalic acid.

Diols employed in the production of the polyalkylene terephthalates according to the invention include for example ethylene glycol, butane-1,4-diol, propane-1,3-diol, tetramethylcyclobutanediol, isosorbitol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane and mixtures thereof (DE-A 2 407 674, 2 407 776, 2 715 932).

Common names of these polyalkylene terephthalates are for example PET, PBT, PETG, PCTG, PEICT, PCT or PTT.

Preferred polyalkylene terephthalates contain at least 80% by weight, preferably at least 90% by weight, based on the dicarboxylic acid component of terephthalic acid radicals and at least 80% by weight, preferably at least 90% by weight, based on the diol component of ethylene glycol and/or butane-1,4-diol radicals.

In a preferred embodiment polyalkylene terephthalates produced solely from terephthalic acid and the reactive derivatives thereof (for example the dialkyl esters thereof) and ethylene glycol and/or butane-1,4-diol and mixtures of these polyalkylene terephthalates are employed as component B.

The polyalkylene terephthalates may be branched through incorporation of relatively small amounts of tri- or tetrahydric alcohols or tri- or tetrabasic carboxylic acids, for example according to DE-A 1 900 270 and U.S. Pat. No. 3,692,744B. Examples of preferred branching agents are trimesic acid, trimellitic acid, trimethylolethane and trimethylolpropane, and pentaerythritol.

Particular preference is given to polyalkylene terephthalates which have been produced solely from terephthalic acid and the reactive derivatives thereof (e.g. the dialkyl esters thereof) and ethylene glycol and/or butane-1,4-diol, and to mixtures of these polyalkylene terephthalates.

In a particularly preferred embodiment, polyethylene terephthalate, polybutylene terephthalate or mixtures of these polyesters are used as component B. The use of polyethylene terephthalate is most preferred.

The preferably employed polyalkylene terephthalates preferably have an intrinsic viscosity of 0.52 dug to 0.95 dl/g, particularly preferably 0.56 dl/g to 0.80 dl/g, very particularly preferably 0.58 dl/g to 0.68 dug. To determine intrinsic viscosity the specific viscosity in dichloroacetic acid is first measured in a concentration of 1% by weight at 25° C. according to DIN 53728-3 in an Ubbelohde viscometer.

The determined intrinsic viscosity is then calculated from the measured specific viscosity×0.0006907+0.063096 (× indicates multiplication).

The polyalkylene terephthalates having the preferred intrinsic viscosity achieve an advantageous balance of mechanical and rheological properties in the compositions according to the invention.

The polyalkylene terephthalates may be produced by known methods (see, for example, Kunststoff-Handbuch, volume VIII, p. 695 ff, Carl-Hanser-Verlag, Munich 1973).

The proportion of component B in the composition is preferably 15 to 45% by weight, more preferably 18 to 40% by weight, particularly preferably 20 to 35% by weight.

Component C

As component C, the composition comprises phosphorous acid H₃PO₃.

Another term is phosphonic acid. In the following, only the term phosphorous acid is used.

The phosphorous acid may be used as a solid or as an aqueous solution. Use as a solid is preferred. In the compositions according to the invention this improves the stability of the polymer components used during compounding and thus improves the mechanical properties of the composition. In addition, metering into the compounding unit is easier than with an aqueous acid solution and the risk of possible corrosion of machine parts is also significantly reduced.

Component C may also be bonded to an organic or inorganic adsorber or absorber and used in this form. This is done for example by mixing the component C with the adsorber or absorber to form a free-flowing powder prior to compounding of the composition. These absorbers or adsorbers are preferably finely divided and/or porous materials having a large external and/or internal surface area.

These materials are preferably thermally inert inorganic materials such as for example oxides or mixed oxides, silicates, silica, sulfides, nitrides of metals or transition metals. In a particularly preferred embodiment these are finely divided and/or microporous silicas or silicon oxides or silicates of natural or synthetic origin.

It is also possible for the phosphorous acid to be employed in the form of a masterbatch based on polycarbonate or polyester. The term masterbatch is to be understood as meaning that the phosphorous acid is premixed with the thermoplastic (polycarbonate or polyester) in a greater quantity than the intended use concentration in the composition. This mixture is then added to the composition in an appropriate amount so that the desired acid concentration in the composition is achieved.

The proportion of component C in the composition is preferably 0.005 to 0.1% by weight, more preferably 0.008 to 0.06% by weight, particularly preferably 0.01 to 0.05% by weight.

Component D The composition comprises a phosphonite as component D. Mixtures of two or more such components may also be used.

Phosphonites are derived from phosphonous acid HP(OH)₂ and have the following general structure (4)

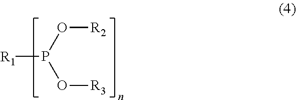

where
n is 1, 2, 3 or 4,
R₁, R₂ and R₃ may be each independently C₁-C₆₀-alkyl, C₆-C₁₂-aryl and C₅-C₁₂ cycloalkyl and hydrogen, where the radicals specified may in each case be substituted by aryl, alkyl, aryloxy, alkyloxy, heteroatoms and/or heterocycles, where R₂ and R₃ cannot be hydrogen at the same time.

The radicals are preferably substituted by C₁-C₅-alkyl, branched C₁-C₅-alkyl, or cumyl, where the substituents may be the same or different.

If the radicals are aryl radicals, these are preferably substituted in the 2 and 4 or 2, 4 and 6 positions. Tert-butyl substituents in these positions are very particularly preferred.

The phosphonites may be mononuclear (n=1) or polynuclear (n=2, 3 or 4), aliphatically, cycloaliphatically and/or aromatically substituted phosphonites.

“Multinuclear” phosphonites are understood to mean those which carry two or more phosphonite groups within one molecule, i.e. single organically substituted phosphorus atoms which in turn carry two organically substituted oxygen atoms.

Alternative names for the structure (4) are “hypophosphorous acid ester” or also “phosphorous acid ester”.

Particularly preferably used as component D is the substance according to structure (5).

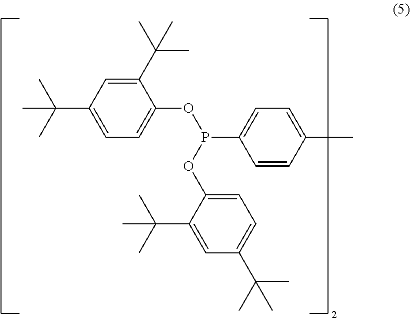

In component D), in addition to structure (5), other isomeric structures thereof may also be present, with structure (5) being the main component.

Compound (5) is classified as CAS: 119345-01-6 and commercially available under the name Irgafos™ P-EPQ from BASF (Germany) The proportion of component D in the composition is preferably 0.05 to 1% by weight, more preferably 0.08 to 0.8% by weight, particularly preferably 0.1 to 0.3% by weight.

Component E

The composition comprises a sterically hindered phenol as component E. Mixtures of two or more such components may also be used.

Particular preference is given to a compound of the general structure (6a) or (6b)

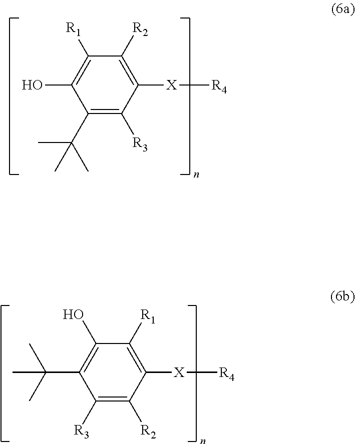

where n is 1, 2, 3 or 4,
R₁, R₂ and R₃ are each independently C₁- to C₄-alkyl or hydrogen
X is a direct bond or a C₁- to C₆₀-organic radical and the organic radical may comprise oxygen and/or nitrogen.
R₄ is a direct bond, carbon, C₁-C₅-alkyl, aryl or a structure according to formula (7a), (7b) or (7c).

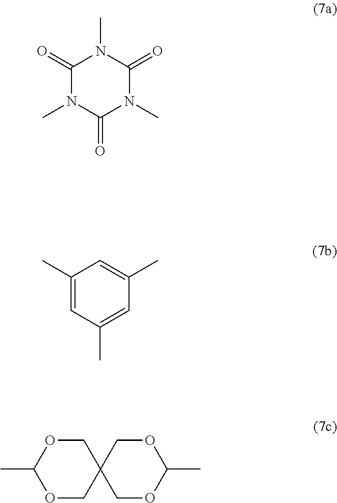

Component E is particularly preferably selected from at least one compound of structures (8) and (9).

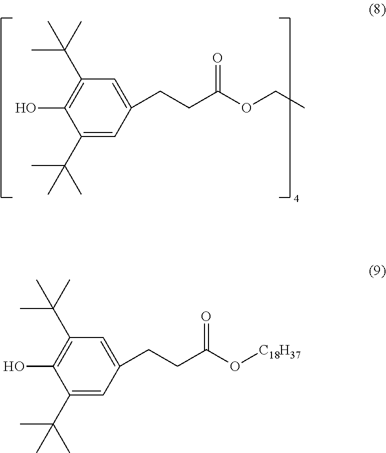

Compound (8) is classified as CAS: 6683-19-8 and commercially available under the name Irganox™ 1010 from BASF (Germany).

Compound (9) is classified as CAS: 2082-79-3 and commercially available under the name Irganox™ 1076 from BASF (Germany).

The proportion of component E in the composition is preferably 0.05 to 1% by weight, more preferably 0.08 to 0.8% by weight, particularly preferably 0.1 to 0.3% by weight.

Component F

As component F, the thermoplastic molding compound may optionally comprise at least one mineral filler based on talc as a reinforcer.

In a preferred embodiment, a mineral filler based on talc is the sole reinforcer.

Suitable as talc-based mineral fillers in the context of the invention are any particulate fillers that the person skilled in the art associates with talc or talcum. Also suitable are all particulate fillers that are commercially available and whose product descriptions contain as characterizing features the terms talc or talcum.

Preference is given to mineral fillers having a content of talc according to DIN 55920 of more than 50% by weight, preferably more than 80% by weight, particularly preferably more than 95% by weight and especially preferably more than 98% by weight based on the total mass of filler.

Talc is to be understood as meaning a naturally occurring or synthetically produced talc.

Pure talc has the chemical composition 3 MgO·4 SiO₂·H₂O and thus an MgO content of 31.9% by weight, an SiO₂ content of 63.4% by weight and a content of chemically bound water of 4.8% by weight, based in each case on the talc. It is a silicate having a layered structure.

Naturally occurring talc materials generally do not have the above-recited ideal composition since they are contaminated through partial replacement of the magnesium by other elements, through partial replacement of silicon by aluminum for example and/or through intergrowth with other minerals, for example dolomite, magnesite and chlorite.

Talc grades particularly preferably used as component F are characterized by particularly high purity, characterized by an MgO content of 28 to 35% by weight, preferably 30 to 33% by weight, particularly preferably from 30.5 to 32% by weight, and an SiO₂ content of 55 to 65% by weight, preferably 58 to 64% by weight, particularly preferably 60 to 62.5% by weight, based in each case on the talc.

The particularly preferred types of talc are also characterized by an Al₂O₃ content of less than 5% by weight, particularly preferably less than 1% by weight, in particular less than 0.7% by weight, based in each case on the talc.

Also advantageous and thus preferred is in particular the use of the talc according to the invention in the form of finely ground grades having an average particle size d₅₀ of 0.1 to 20 μm, preferably 0.2 to 10 μm, more preferably 0.5 to 5 μm, still more preferably 0.7 to 2.5 μm and particularly preferably 1.0 to 2.0 μm.

The talc-based mineral fillers for use in accordance with the invention preferably have an upper particle size or grain size d₉₅ of less than 10 μm, preferably less than 7 μm, particularly preferably less than 6 μm and especially preferably less than 4.5 μm. The d₉₅ and d₅₀ values of the fillers are determined by SEDIGRAPH D 5 000 sedimentation analysis according to ISO 13317-3.

The talc-based mineral fillers may optionally have been subjected to a surface treatment to achieve better coupling to the polymer matrix. They may for example have been provided with an adhesion promoter system based on functionalized silanes.

The average aspect ratio (diameter to thickness) of the particulate fillers is preferably in the range 1 to 100, particularly preferably 2 to 25 and especially preferably 5 to 25, determined by electron micrographs of ultrathin sections of the finished products and measurement of a representative amount (ca. 50) of filler particles.

As a result of the processing to afford the molding compound/molded bodies, the particulate fillers may have a smaller d₉₅/d₅₀ in the molding compound/in the molded body than the originally used fillers.

The proportion of component F in the composition is preferably 0 to 25% by weight, more preferably 0 to 20% by weight, particularly preferably 5 to 20% by weight.

Component G

The composition may comprise commercially available polymer additives as component G. Commercially available polymer additives of component E include additives such as, for example, internal and external lubricants and mold-release agents (for example pentaerythritol tetrastearate, montan wax or polyethylene wax), flame retardants, flame retardant synergists, conductivity additives (for example conductive carbon black or carbon nanotubes), UV/light protectants, nucleating agents (for example sodium phenylphosphinate, aluminum oxide, silicon dioxide, salts of aromatic carboxylic acids), hydrolysis protectants, scratch resistance-improving additives (for example silicone oils), IR absorbers, optical brighteners, fluorescent additives, impact modifiers (with or without core-shell structure), further polymeric blend partners, and also dyes and pigments (for example titanium dioxide, ultramarine blue, iron oxide, carbon black, phthalocyanines, quinacridones, perylenes, nigrosine and anthraquinones) and fillers and reinforcers (distinct from component F) or else mixtures of a plurality of the additives cited.

The further reinforcer is preferably selected from the group consisting of mica, silicate, quartz, titanium dioxide, kaolin, amorphous silicas, magnesium carbonate, chalk, feldspar, barium sulfate, glass spheres, ceramic spheres, wollastonite and glass fibers.

The compositions according to the invention preferably contain at least one mold-release agent, preferably pentaerythritol tetrastearate.

In a preferred embodiment the composition comprises as component G at least one additive selected from the group comprising lubricants and mold-release agents, UV/light protectants, antistats, dyes, pigments and fillers and reinforcers (distinct from component F).

The additives may be employed alone or in admixture/in the form of masterbatches.

In a preferred embodiment, the composition is free from other fillers and reinforcers other than component F.

In a preferred embodiment the composition is free from rubber-modified graft polymers.

In a preferred embodiment the composition is free from vinyl (co)polymers, in particular SAN (styrene-acrylonitrile).

In a preferred embodiment the composition is free from phosphorus-based flame retardants.

Free from a component is to be understood as meaning that less than 0.5% by weight, preferably less than 0.1% by weight, especially preferably 0% by weight, of this component is present in the composition.

The proportion of component G in the composition is preferably 0 to 20% by weight, more preferably 0.1 to 15% by weight, particularly preferably 0.2 to 10% by weight.

Production of the Molding Compounds and Molded Bodies

The compositions according to the invention may be used to produce thermoplastic molding compounds. The thermoplastic molding compounds according to the invention may be produced for example when the respective constituents of the compositions are in familiar fashion mixed and melt-compounded and melt-extruded at temperatures of preferably 200° C. to 320° C., particularly preferably at 240° C. to 310° C., very particularly preferably at 260° C. to 300° C., in customary apparatuses such as internal kneaders, extruders and twin-screw extruders for example. In the context of the present application this process is generally referred to as compounding.

The term “molding compound” is thus to be understood as meaning the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. This means that, for example, some of the constituents may be metered in via the main intake of an extruder and the remaining constituents may be introduced later in the compounding process via a side extruder.

The molding compounds according to the invention may be used to produce molded bodies and semifinished products of any kind. These may be produced by injection molding, extrusion and blow molding processes for example. A further form of processing is the production of molded bodies by thermoforming from previously produced sheets or films. The molding compounds according to the invention are particularly suitable for processing by extrusion, blow-molding and thermoforming methods.

Examples of semifinished products include sheets.

It is also possible to meter the constituents of the compositions directly into an injection molding machine or into an extrusion unit and to process them to give molded bodies.

Examples of such molded bodies that are producible from the compositions and molding compounds according to the invention are films, profiles, housing parts of any kind, for office machines such as monitors, flatscreens, notebooks, printers, copiers; sheets, pipes, electrical installation ducts, windows, doors and other profiles for the construction sector and also electrical and electronic components such as switches, plugs and sockets, and parts for vehicles, in particular for the automotive sector. The compositions and molding compounds according to the invention are also suitable for producing the following molded bodies or moldings: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, molded parts for sanitation and bath equipment, protective grilles for ventilation openings and housings for garden equipment.

The present invention further relates to molded bodies produced from the aforementioned compositions, preferably sheetlike moldings such as sheets and vehicle body parts such as mirror housings, fenders, spoilers, hoods etc.

The molded bodies may be small or large and employed for exterior or interior applications. It is preferable to produce large moldings for vehicle construction, especially the automotive sector. The molding compounds according to the invention may especially be used for fabricating vehicle body exterior parts, for example fenders, trunk lids, engine hoods, bumpers, load beds, covers for load beds, vehicle roofs or other vehicle body accessory parts.

Molded bodies/semifinished products made of the molding compounds/compositions according to the invention may also be disposed in composites with further materials, for example metal or plastic. After any painting of for example vehicle body exterior parts, paint layers may be disposed directly on the molding compounds according to the invention and/or on the materials used in the composite. The molding compounds according to the invention and the moldings/semifinished products made of the molding compounds according to the invention may be used for producing finished parts such as for example vehicle body exterior parts in composites with other materials or themselves through customary techniques of bonding and joining several components or parts such as for example coextrusion, film insert molding, overmolding of inserts, adhesive bonding, welding, screwing or clamping.

Further embodiments 1 to 40 of the present invention are described hereinbelow:
1. Composition for producing a thermoplastic molding compound, wherein the composition comprises the following constituents:
   A) at least one polymer selected from the group consisting of polycarbonate and polyester carbonate,
   B) at least one polyester,
   C) phosphorous acid,
   D) at least one phosphonite,
   E) at least one sterically hindered phenol.
2. Composition according to embodiment 1, characterized in that the component A is an aromatic polycarbonate and has a weight-average molecular weight MW, determined by gel permeation chromatography in methylene chloride using polycarbonate based on bisphenol A as standard, of 22 to 28 kg/mol.
3. Composition according to embodiment 1 or 2, characterized in that component A is an aromatic polycarbonate based on bisphenol A.
4. Composition according to any of the preceding embodiments, characterized in that the component B contains structural units derived from terephthalic acid and up to 50 mol % of structural units from phthalic acid, isophthalic acid, naphthalene-2,6-dicarboxylic acid, 4,4′-diphenyldicarboxylic acid, succinic acid, adipic acid, and cyclohexanedicarboxylic acid.
5. Composition according to any of the preceding embodiments, characterized in that the component B contains no structural units of an acid other than terephthalic acid and isophthalic acid.
6. Composition according to any of the preceding embodiments, characterized in that the component B contains no structural units of an acid other than terephthalic acid.
7. Composition according to any of the preceding embodiments, characterized in that component B contains structural units derived from ethylene glycol, butane-1,4-diol, propanediol, cyclohexane-1,4-dimethanol, tetramethylcyclobutanediol and isosorbitol.
8. Composition according to any of the preceding embodiments, characterized in that component B is selected from the group consisting of polyethylene terephthalates and polybutylene terephthalates.
9. Composition according to any of the preceding embodiments, characterized in that a polyethylene terephthalate having an intrinsic viscosity of 0.52 dl/g to 0.95 dl/g is employed as component B.
10. Composition according to any of the preceding embodiments, characterized in that a polyethylene terephthalate having an intrinsic viscosity of 0.56 dl/g to 0.80 dl/g is employed as component B.
11. Composition according to any of the preceding embodiments, characterized in that a polyethylene terephthalate having an intrinsic viscosity of 0.58 dl/g to 0.68 dl/g is employed as component B.
12. Composition according to any of the preceding embodiments comprising
40% to 80% by weight of component A,
15% to 45% by weight of component B,
0.005% to 0.1% by weight of the component C,
0.05% to 1% by weight of the component D,
0.05 to 1% by weight of component E,
F) 0 to 25% by weight of a mineral filler based on talc and
G) 0 to 20% by weight of at least one additive selected from the group consisting of lubricants and mold-release agents, flame retardants, flame retardant synergists, conductivity additives, UV/light protectants, nucleating agents, hydrolysis protectants, scratch resistance improving additives, IR absorbents, optical brighteners, fluorescent additives, impact modifiers, dyes and pigments, and also fillers and reinforcers other than component F.
13. Composition according to any of the preceding embodiments, characterized in that the proportion of component A in the composition is 40 to 80% by weight, more preferably 45 to 75% by weight, particularly preferably 50 to 66% by weight.
14. Composition according to any of the preceding embodiments, characterized in that the proportion of component B in the composition is 15 to 45% by weight, more preferably 18 to 40, particularly preferably 20 to 35% by weight.
15. Composition according to any of the preceding embodiments, characterized in that the proportion of component C in the composition is 0.005 to 0.1% by weight, more preferably 0.008 to 0.06% by weight, particularly preferably 0.01 to 0.05% by weight.
16. Composition according to any of the preceding embodiments, characterized in that the proportion of component D in the composition is 0.05 to 1% by weight, more preferably 0.08 to 0.8% by weight, particularly preferably 0.1 to 0.3% by weight.
17. Composition according to any of the preceding embodiments, characterized in that the proportion of component E in the composition is 0.05 to 1% by weight, preferably 0.08 to 0.8% by weight, more preferably 0.1 to 0.3% by weight.
18. Composition according to any of the preceding embodiments, characterized in that the proportion of component F in the composition is 0 to 25% by weight, more preferably 0 to 20% by weight, particularly preferably 5 to 20% by weight.
19. Composition according to any of the preceding embodiments, characterized in that the proportion of component G in the composition is 0 to 20% by weight, more preferably 0.1 to 15% by weight, particularly preferably 0.2 to 10% by weight.
20. Composition according to any of the preceding embodiments comprising
50% to 66% by weight of component A,
20% to 35% by weight of component B,
0.01% to 0.05% by weight of the component C,
0.1% to 0.3% by weight of the component D,
0.1 to 0.3% by weight of component E,
5% to 20% by weight of component F and
0.2% to 10% by weight of component G.
21. Composition according to any of the preceding embodiments, characterized in that component C is used as a solid.
22. Composition according to any of the preceding embodiments, characterized in that component C is used bonded to an organic or inorganic adsorber or absorber.
23. Composition according to embodiment 20, characterized in that component C is used bonded to silica.
24. Composition according to any of the preceding embodiments, characterized in that the compound according to structure (5) is used as component D.

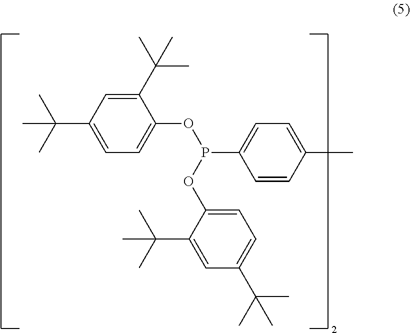

25. Composition according to any of the preceding embodiments, characterized in that component E is selected from at least one compound according to structures (8) and (9)

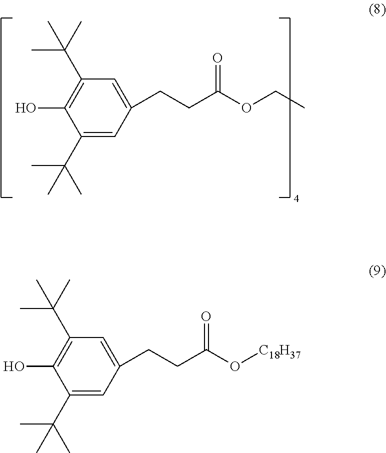

26. Composition according to any of the preceding embodiments, characterized in that a talc having an Al₂O₃ content of less than 0.7% by weight is used as component F.
27. Composition according to any of the preceding embodiments, characterized in that component F has an upper grain size d₉₅ of less than 6 μm.
28. Composition according to any of the preceding embodiments comprising no fillers and reinforcers other than component F.
29. Composition according to any of the preceding embodiments, characterized in that the composition is free from rubber-modified graft polymers.
30. Composition according to any of the preceding embodiments, characterized in that the composition is free from vinyl (co)polymers.
31. Composition according to any of the preceding embodiments, characterized in that the composition is free from styrene-acrylonitrile copolymers.
32. Composition according to any of the preceding embodiments, characterized in that the composition is free from phosphorus-based flame retardants.
33. Composition according to any of the preceding embodiments, characterized in that the composition is free from carbon fibers.
34. Composition according to any of the preceding embodiments consisting to an extent of 90% by weight of the components A to G.
35. Composition according to any of the preceding embodiments consisting to an extent of 95% by weight of the components A to G.
36. Composition according to any of the preceding embodiments consisting of components A to G.
37. Process for producing a molding compound, characterized in that the constituents of a composition according to any of embodiments 1 to 36 are mixed with one another at a temperature of 200° C. to 320° C. and subsequently cooled and pelletized.
38. Molding compound obtainable by a process according to embodiment 37.
39. Use of a composition according to any of embodiments 1 to 36 or of a molding compound according to embodiment 37 for producing molded bodies.
40. Molded body obtainable from a composition according to any of embodiments 1 to 36 or from a molding compound according to embodiment 38.

### EXAMPLES

Component A-1

Linear polycarbonate based on bisphenol A having a molecular weight of 24 kg/mol (weight-average MW, measured by GPC (gel permeation chromatography) using a polycarbonate standard based on bisphenol A).

Component A-2 Linear polycarbonate based on bisphenol A having a molecular weight of 28 kg/mol (weight-average MW, measured by GPC (gel permeation chromatography) using a polycarbonate standard based on bisphenol A).

Component B-1

Polyethylene terephthalate (for example PET from Invista, Germany) having an intrinsic viscosity of 0.623 dug. The specific viscosity is measured in dichloroacetic acid at a concentration of 1% by weight at 25° C. The intrinsic viscosity is calculated from the specific viscosity according to the following formula.

Intrinsic viscosity=specific viscosity×0.0006907+0.063096

Component B-2

Polyethylene terephthalate (for example PET from Invista, Germany) having an intrinsic viscosity of 0.664 dug. The specific viscosity is measured in dichloroacetic acid in a concentration of 1% by weight at 25° C. The intrinsic viscosity is calculated from the specific viscosity according to the following formula.

Intrinsic viscosity=specific viscosity×0.0006907+0.063096

Component C-1

Phosphorous acid H₃PO₃ as a solid, Sigma-Aldrich Chemie GmbH (Germany) Component C-2 (comparison)
Zn (H₂PO₄)₂, Budit™ T21, Budenheim (Germany)

Component D-1

Dimeric phosphonite according to structure (5), tetrakis(2,4-di-tert-butylphenyl)-1,1-biphenyl-4,4′-diyl bisphosphonite, Irgafos™ P-EPQ, BASF (Germany)

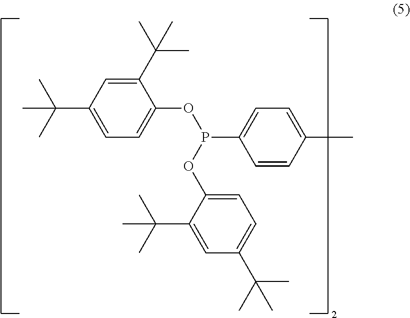

Component D-2 (comparison):

Phosphite stabilizer according to structure (10), Irgafos™ 168, tris(2,4-di-tert-butyl-phenyl)phosphite); BASF (Germany)

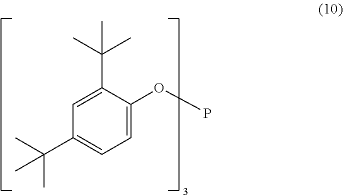

Component E-1

Sterically indered phenol according to structure (8), Irganox™ 1010, pentaerythritol tetrakis(3-(3,5-di-tert-butyl-4-hydroxyphenyl)propionate), BASF (Germany)

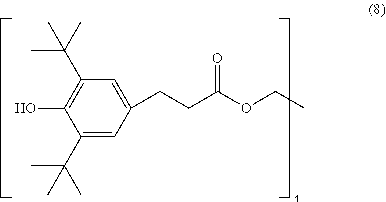

Component E-2

Sterically indered phenol according to structure (9), Irganox™ 1076, octadecyl 3-[3,5-di-tert-butyl-4-hydroxyphenyl]propionate, BASF (Germany)

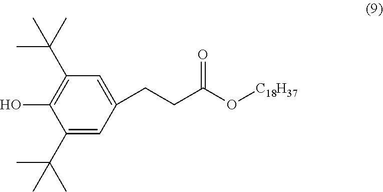

Component F

Talc having an average particle diameter cis( ) from 1.2 μm and a d₉₅ of 3.5 μm measured using a sedigraph and having an Al₂O₃ content of 0.5% by weight, Jetfine™ 3CA from Imerys Talc (Austria)

Component G-1

Pentaerythritol tetrastearate as mold-release agent, Cognis Oleochemicals GmbH, Germany

Component G-2

Montanic acid ester wax (Licowax™ E) as a lubricant/mold-release agent

Component G-3

Carbon black, Black Pearls™ 800, Cabot

Production of the Molding Compounds

The molding compounds according to the invention comprising the components A to E are produced on a ZSK25 twin-screw extruder from Coperion, Werner and Pfleiderer (Germany) at melt temperatures of 270° C.

Production of the Test Specimens and Testing

The pellets obtained from the respective compounding were processed into test specimens on an injection molding machine (for example from Arburg) at a melt temperature of 270° C. and a mold temperature of 70° C.

The heat distortion resistance was measured in accordance with DIN ISO 306 (Vicat softening temperature, method B with a load of 50 N and a heating rate of 120 K/h, version from 2013) on a test bar having the dimensions 80×10×4 mm injected on one side, produced at 270° C. and a dwell time of 43 s. Furthermore, a Vicat softening temperature was measured on test bars which were produced at 300° C. with a residence time of 129 s. The difference Delta Vicat=Vicat (test specimen 270° C., 43 s dwell time)−Vicat (test specimen 300° C., 129 s dwell time) is given as a measure of the thermal load capacity.

Impact strength is determined according to ISO 180/1U (1982 version) at room temperature (23° C.) by a 10-fold determination on test bars measuring 80 mm×10 mm×4 mm

The glass transition temperature of the polycarbonate (T_{g} PC), the melting temperature of the polyester (Tₘ PET) and the crystallization temperature of the polyester (T_{c} PET) were measured using Differential Scanning Calorimetry (DSC) according to ISO 11357-3:2018: Determination of temperature and enthalpy of melting and crystallization determined using a Mettler DSC 3+ instrument. The measurement was carried out in a temperature range from −40° C. to 320° C. at a heating rate of 10 K/min in a nitrogen atmosphere (50 ml N₂/min). In this case, it was heated and cooled several times. T_{g} was determined in each case as the midpoint of the glass transition during the second heating and the first cooling. Tₘ was determined as the peak temperature during the second heating and T_{c} as the peak temperature during the first cooling.

If the melting temperature of the polyester (Tₘ PET) and/or the crystallisation temperature of the polyester (T_{c} PET) could not be determined due to unstable phase behavior/thermal damage of the investigated material, this is marked as “not measurable”.

The examples which follow serve to further elucidate the invention.

TABLE 1

| Component (parts by weight) | | C1 | C2 | 3 | 4 | 5 |
|---|---|---|---|---|---|---|
| A-1 | | 61.2 | 61.1 | 60.7 | 60.7 | 60.7 |
| B-1 | | 22.5 | 22.5 | 23.0 | 23.0 | 23.0 |
| C-1 | | | | 0.010 | 0.025 | 0.050 |
| C-2 | | | | | | |
| D-1 | | 0.1 | 0.2 | 0.1 | 0.1 | 0.1 |
| D-2 | | | | | | |
| E-1 | | 0.2 | 0.2 | 0.2 | 0.2 | 0.2 |
| F | | 15.0 | 15.0 | 15.0 | 15.0 | 15.0 |
| G-1 | | 0.36 | 0.36 | 0.36 | 0.36 | 0.36 |
| G-2 | | 0.2 | 0.2 | 0.2 | 0.2 | 0.2 |
| G-3 | | 0.45 | 0.45 | 0.45 | 0.45 | 0.45 |
| Properties | Units | | | | | |
| Delta Vicat | ° C. | 16 | 12 | 2 | 1 | 1 |
| Izod impact strength 23° C. | kJ/m² | 82 | 77 | 80 | 77 | 74 |
| T_{g} PC (DSC) 2nd heating | ° C. | 115 | 114 | 139 | 140 | 139 |
| Tₘ PET (DSC) 2nd heating | ° C. | n.m.* | n.m.* | 251 | 251 | 251 |
| T_{c} PET (DSC) 1st cooling | ° C. | n.m.** | n.m.** | 217 | 215 | 215 |
| T_{g} PC (DSC) 1st cooling | ° C. | 112 | 113 | 136 | 137 | 135 |

| Component (parts by weight) | | C6 | C7 | C8 | C9 | C10 | C11 |
|---|---|---|---|---|---|---|---|
| A-1 | | 61.2 | 61.2 | 61.2 | 60.7 | 61.4 | 61.4 |
| B-1 | | 22.5 | 22.5 | 22.5 | 23.0 | 22.6 | 22.6 |
| C-1 | | 0.010 | 0.025 | 0.050 | | 0.025 | 0.05 |
| C-2 | | | | | 0.025 | | |
| D-1 | | | | | 0.1 | | |
| D-2 | | 0.1 | 0.1 | 0.1 | | | |
| E-1 | | 0.2 | 0.2 | 0.2 | 0.2 | | |
| F | | 15.0 | 15.0 | 15.0 | 15.0 | 15.0 | 15.0 |
| G-1 | | 0.36 | 0.36 | 0.36 | 0.36 | 0.36 | 0.36 |
| G-2 | | 0.2 | 0.2 | 0.2 | 0.2 | 0.2 | 0.2 |
| G-3 | | 0.45 | 0.45 | 0.45 | 0.45 | 0.45 | 0.45 |
| Properties | Unit | | | | | | |
| Delta Vicat | ° C. | 4 | 2 | 2 | 3 | 2 | 2 |
| Izod impact strength 23° C. | kJ/m² | 67 | 65 | 66 | 67 | 74 | 58 |
| T_{g} PC (DSC) 2nd heating | ° C. | 123 | 134 | 137 | 135 | 134 | 138 |
| Tₘ PET (DSC) 2nd heating | ° C. | 238 | 244 | 251 | 244 | 245 | 251 |
| T_{c} PET (DSC) 1st cooling | ° C. | 207 | 206 | 218 | 203 | 209 | 214 |
| T_{g} PC (DSC) 1st cooling | ° C. | 119 | 131 | 134 | 135 | 134 | 134 |

*n.m. = not measurable, i.e. melting temperature can no longer be determined using DSC measurement
**n.m. = not measurable, i.e. crystallization temperature can no longer be determined using DSC measurement

TABLE 2

| Component (parts by weight) | | C12 | C13 | 14 |
|---|---|---|---|---|
| A-2 | | 69.8 | 69.9 | 69.8 |
| B-2 | | 29.5 | 29.6 | 29.5 |
| C | | | 0.02 | 0.02 |
| D-1 | | 0.2 | | 0.2 |
| E-2 | | 0.2 | 0.2 | 0.2 |
| G-1 | | 0.36 | 0.36 | 0.36 |
| Properties | Unit | | | |
| Delta Vicat | ° C. | 9 | 8 | 7 |
| Izod impact strength 23° C. | kJ/m² | n.d. | n.d. | n.d. |
| T_{g} PC (DSC) 2nd heating | ° C. | 132 | 134 | 139 |
| Tₘ PET (DSC) 2nd heating | ° C. | 246 | 252 | 254 |
| T_{c} PET (DSC) 1st cooling | ° C. | **n.m. | 192 | 198 |
| T_{g} PC (DSC) 1st cooling | ° C. | 131 | 134 | 136 |

n.d. = no fracture
**n.m. = not measurable, i.e. crystallization temperature can no longer be determined using DSC measurement

Table 1 shows that the compositions according to the invention comprising components C, D and E enable the production of molded bodies with a slight reduction in heat distortion temperature after high thermal stress (Delta Vicat) in combination with improved impact strength. Furthermore, the DSC investigations show that the respective transition temperatures of the polycarbonate and polyester components are at a high level both during multiple heating and during repeated cooling and therefore a good preservation of the phase separation and phase stability can be assumed.

If component C is not used (V1), the heat distortion temperature drops significantly under high thermal stress and the polycarbonate and polyester components are mixed in an undesirable manner Even increased addition of component D cannot compensate for the lack of component C.

If component D is not a phosphonite but a phosphite (C6, C7 and C8), the resilience in particular is not at the desired level.

If an acidic phosphate salt is used as component C (C9), the resilience is also reduced and the transition temperatures are lowered.

If only component C according to the invention is used, but components D and E are missing, the transition temperatures are lowered for the same amount of component C (Ex. 4 compared to C10). This cannot be compensated for by a higher amount of component C, because then the impact strength decreases significantly (C12).

The advantages of combining components C, D and E are also evident in compositions without mineral filler (Table 2).

1: A composition for producing a thermoplastic molding compound, wherein the composition comprises the following constituents:
A) at least one polymer selected from the group consisting of polycarbonate and polyester carbonate,
B) at least one polyester,
C) phosphorous acid,
D) at least one phosphonite,
E) at least one sterically hindered phenol.

2: The composition according to claim 1, wherein component A is an aromatic polycarbonate and has a weight-average molecular weight M_{w}, determined by gel permeation chromatography in methylene chloride using polycarbonate based on bisphenol A as standard, of 22 to 28 kg/mol.

3: The composition according to claim 1, wherein component B is selected from the group consisting of polyethylene terephthalates and polybutylene terephthalates.

4: The composition according to claim 3, wherein a polyethylene terephthalate having an intrinsic viscosity of 0.58 dl/g to 0.68 dl/g is used as component B.

5: The composition according to claim 1, comprising
40% to 80% by weight of component A,
15% to 45% by weight of component B,
0.005% to 0.1% by weight of component C,
0.05% to 1% by weight of component D,
0.05 to 1% by weight of component E,
F) 0 to 25% by weight of a mineral filler based on talc and
G) 0 to 20% by weight of at least one additive selected from the group consisting of lubricants and mold-release agents, flame retardants, flame retardant synergists, conductivity additives, UV/light protectants, nucleating agents, hydrolysis protectants, scratch resistance improving additives, IR absorbents, optical brighteners, fluorescent additives, impact modifiers, dyes and pigments, fillers, and reinforcers other than component F.

6: The composition according to claim 1, wherein component C is a solid.

7: The composition according to claim 1, wherein the proportion of component C in the composition is 0.01 to 0.05% by weight.

8: The composition according to claim 1, wherein a compound according to structure (5) is component D.

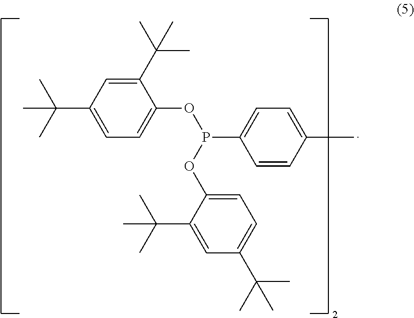

9: The composition according to claim 1, wherein component F has an upper grain size d₉₅ of less than 6 μm.

10: The composition according to claim 1.

11: The composition according to claim 1 consisting of components A to G.

12: A process for producing a molding compound, the process comprising mixing together constituents A through E to form a mixture according to claim 1 at a temperature of 200° C. to 320° C. and subsequently cooling and pelletizing the mixture.

13: A molding compound obtained by the process according to claim 12.

14. (canceled)

15: A molded body comprising the molding compound according to claim 13.
